(19) United States
(12) Patent Application Publication
(10) Pub. No.: US 2004/0225807 A1
(43) Pub. Date: Nov. 11, 2004

(54) Method and assembly having a matched filter connector

(76) Inventors: Michael W. Leddige, Beaverton, OR (US); James A. McCall, Beaverton, OR (US)

Correspondence Address: KENYON & KENYON, 1500 K STREET, N.W., SUITE 700, WASHINGTON, DC, 20005, US

(21) Appl. No.: 09/791,810

(22) Filed: Feb. 26, 2001

(51) Int. Cl. G06F 13/38; G06F 13/40

(52) U.S. Cl. 710/305

(57) ABSTRACT

A method is provided for designing a computer assembly. This may include obtaining a design of the computer assembly having a transmission line and a connection portion, and matching an impedance value of the transmission line to an impedance value of the connection portion so as to obtain a desired filter characteristic. A computer assembly may also be provided that includes a motherboard, a module and a transmission line. A connection transition may be designed such that an impedance of the transmission line matches an impedance of the connection transition and to obtain a desired filter characteristic.

### FIELD

The present invention relates to connections between printed circuit boards.

### BACKGROUND

Computer systems may employ a serial bus to transmit signals between a memory controller and memory. An example of such a serial bus has been developed by Rambus Corporation of Mountain View, Calif. That bus, often called the Direct Rambus memory channel, enables transmission of high speed, pipelined signals between a memory controller and memory. A memory card or module coupled to the bus may contain a number of high speed DRAMs (dynamic random access memory) that have a Rambus developed architecture. Such memory devices are often called “Rambus DRAMs” or “RDRAMs”.

The Direct Rambus memory channel may require signals to travel from a motherboard to a memory card. The memory card may be inserted into a socket (or connector) that is mounted to the motherboard. That socket may introduce an impedance discontinuity into the signal line (or transmission line) that could adversely affect system performance such as by requiring reduction in the maximum frequency at which high speed, pipelined electrical signals may be driven along the channel. This may prevent signal reflection and degrade signal quality.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto.

The following represents brief descriptions of the drawings in which like reference numerals represent like elements and wherein:

FIG. 1 is a side view of a computer assembly having a pair of memory cards inserted into a pair of sockets on a motherboard;

FIG. 2 is a cross-section of the computer assembly of FIG. 1;

FIG. 3 is a top view of a motherboard that may be used to make the computer assembly shown in FIG. 2;

FIG. 4 is a drawing showing a driver and receiver implementation having two connector transitions;

FIG. 5 is a drawing of a low-pass filter ladder network utilizing inductance and capacitance electrical characteristics of a connector; and

FIG. 6 is a graphical representation of an output of a driver and an input of a receiver.

### DETAILED DESCRIPTION

Before beginning a detailed description of the subject invention, mention of the following is in order. When appropriate, like reference numerals and characters may be used to designate identical, corresponding or similar components in differing figure drawings. Arrangements may be shown in block diagram form in order to avoid obscuring the invention, and also in view of the fact that specifics with respect to implementation of such block diagram arrangements may be dependent upon the platform within which the present invention is to be implemented. That is, specifics are well within the purview of one skilled in the art. Where specific details are set forth in order to describe example embodiments of the invention, it should be apparent to one skilled in the art that the invention can be practiced without these specific details.

The present invention may be described with respect to a signal(s), a signal line(s), a transmission line(s) and a bus. These terminologies are intended to be interchangeable among each other and between the single and the plural.

Any reference to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

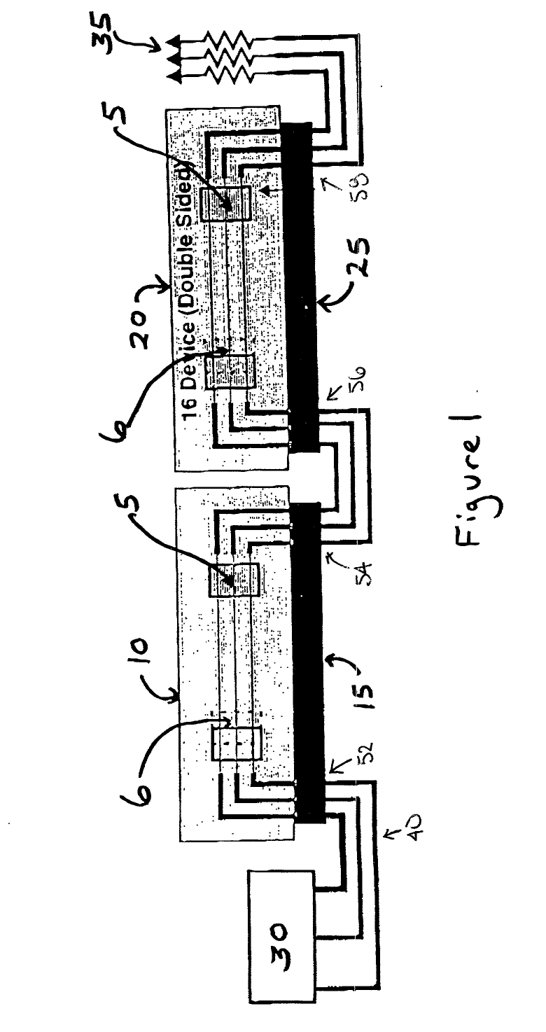

FIG. 1 is a side view of a pair of memory cards inserted into a pair of sockets (or connectors). FIG. 1 generally shows a Direct Rambus memory channel that includes memory cards 10 and 20 inserted into sockets 15 and 25, which have been mounted to a motherboard. The sockets 15 and 25 may be part of RIMM (Rambus Inline Memory Module) connectors and include connection transitions 52, 54, 56 and 58 where a transmission line 40 passes from a motherboard into the memory cards 10 and 20 or passes from the memory cards 10 and 20 to the motherboard. A plurality of memory devices 5 may be mounted onto the memory cards 10 and 20. The memory cards 10 and 20 may also include memory devices in addition to those shown, which may be mounted on both sides of the cards 10 and 20. For example, each memory card 10 and 20 may include 16 memory devices by having 8 memory devices mounted to each side. High speed, pipelined signals may travel from a memory controller 30 (or chipset) through the cards 10 and 20 to termination resistors 35 or any other element. The controller 30 may be a Rambus ASIC (application-specific integrated circuit) controller that is coupled to the transmission line 40 by a socket. The signals may travel from the memory controller 30 to the resistors 35 along a single or a plurality of transmission lines 40. As those signals travel from one end of the memory channel to the other end, the sockets 15 and 25 may act as inductors and may also apply a small amount of capacitance to the signals that pass through them. The average impedance resulting from the combination of such a socket, vias located on both the motherboard and a memory card, and the memory card's edge fingers (or pads) is a function of the inductance and the capacitance that these elements apply.

When the inductance of a socket is relatively high, then the average impedance (over the motherboard to the memory card connection) may be higher than desired. A signal trace may pass from the motherboard to the memory card and create an unwanted impedance discontinuity. It is therefore desirable to reduce the impedance discontinuity over a memory channel that transmits high speed, pipelined signals.

A computer assembly will now be described that includes a motherboard and a socket mounted to the motherboard. The socket is capable of receiving a memory card (such as one of the memory cards 10 and 20). The socket may have a mounting pin that is inserted into a via formed in the motherboard. The computer assembly may also include a stub trace that is coupled to the via to add capacitance at the via.

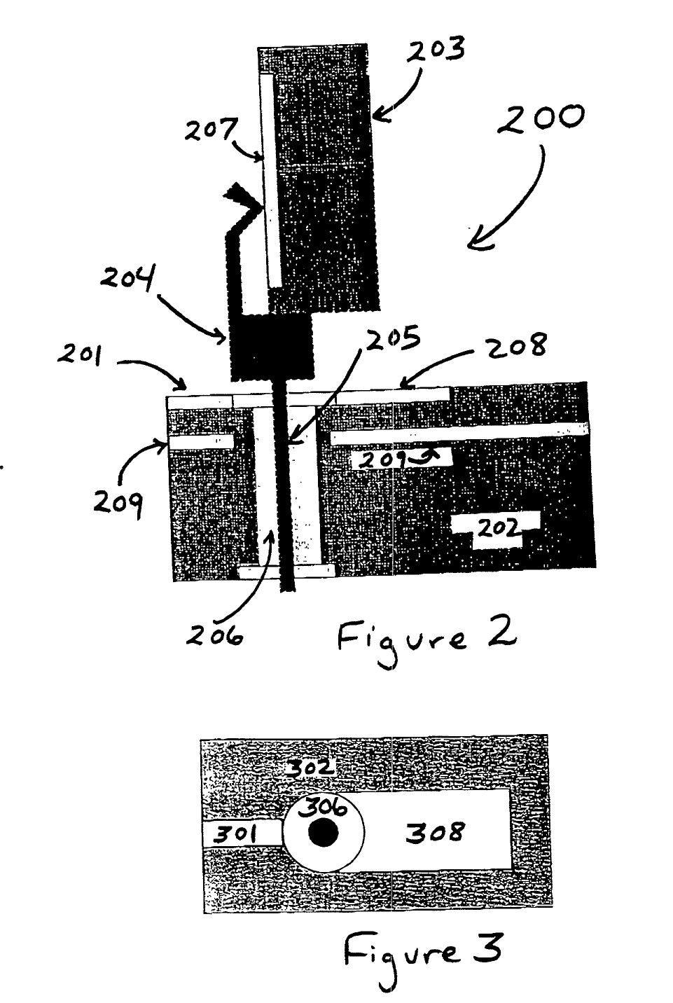

FIG. 2 is a cross-section of a computer assembly 200 that includes a high speed, pipelined memory channel. When used, the computer assembly 200 may cause signals to be transmitted along a trace 201, which is formed on a surface of a motherboard 202. Those signals may pass from the motherboard 202 to edge fingers 207 formed on a memory card 203 (such as the memory card 10). A socket 204 may be mounted to the motherboard 202 by inserting a mounting pin 205 into a via 206 and performing a soldering step. The socket 204 may make electrical contact with the edge fingers 207.

When standard components and tools are used to make the computer assembly of FIG. 2, the impedance of the trace 201 may differ from the average impedance of the signal line as it extends from the via 206 through the socket 204 to the edge fingers 207. To minimize any such discontinuity, a stub trace 208 may be formed on the motherboard 202 to increase the capacitance at the via 206. The amount of capacitance that the stub trace 208 adds may depend upon the amount of separation between the stub trace 208 and a ground plane 209. Similarly, the amount of capacitance that the via 206 adds to the signal line may depend upon the amount of separation between the via 206 and the ground plane 209. As one example, the stub trace 208 may be placed next to the via 206 on a side opposite the trace 201. The stub trace 208 may add between about 0.1 and about 1.5 picofarad of capacitance to the signal line in this example.

A stub trace may be added to the memory card 203 in addition to adding the stub trace 208 to the motherboard 202. This may add capacitance or balance the amount of capacitance added to the motherboard/memory card connection across that connection. Such a stub trace (not shown) may be coupled to a via (not shown) that is associated with the edge finger 207. Like the stub trace 208, when such a stub trace is added to a via that is formed on the memory card 203, that stub trace may add between about 0.1 and about 1.5 picofarad of capacitance at the via. When stub traces are added to both the motherboard 202 and the memory card 203, they may apply, in combination, between about 0.2 and about 3.0 picofarad of capacitance to the signal trace. To assure acceptable performance, the added capacitance may be adjusted such that the overall electrical delay resulting from the presence of the stubs, the socket, the motherboard and memory card vias, and the edge finger (or pad) is less than one-half of the signal rise time.

FIG. 3 is a top view of a motherboard that may be used to make the computer assembly shown in FIG. 2. The motherboard 302 may include a via 306 (for receiving a socket's mounting pin), a trace 301 and a stub trace 308. A trace 301 may be coupled to a first part of the via 306's perimeter. The stub trace 308 may be coupled to a second part of the via 306's perimeter to add capacitance at the via. The stub trace 308 may be located directly across the via from the trace 301 and may be rectangular in shape. The trace 301 and the stub trace 308 may, however, assume a different orientation from the one depicted here. In addition, the particular shape of the trace 308 may be immaterial as long as it serves its intended function, i.e., adding capacitance at the via.

As discussed above, it is desired to minimize connector impedance discontinuities especially as bus operating frequencies increase. This may be further accomplished by matching electrical properties (i.e., capacitance and inductance) of the connector to electrical properties (i.e., capacitance and impedance) of the bus (or transmission line). Bus operation data rates may reach as high as 10 Gb/s and signal data cycles may be on the order of 100 ps. Thus, physical structures such as connectors may be electrically long as compared to the data bit time. As discussed above, connector impedance discontinuity may be minimized by making the connector impedance match the bus impedance.

In accordance with embodiments of the present invention, performance of the bus may be further increased by limiting the bus bandwidth. This may be accomplished by using a connector (or connector component) as an in-line, matched, low phase distortion filter (such as a bessel filter). This may reduce design complexity and maximize the signal integrity. Accordingly, embodiments of the present invention may adjust parasitics (i.e., electrical properties) of the connector or connector components to achieve the effects of a filter such as a bessel filter or any other desired filter function. More specifically, parasitics such as the inductance (L) and the capacitance (C) of the connector, vias, pads and/or edge fingers may be adjusted to match or approximate desired filter functions. This may be achieved by identifying electrical values to match the impedance characteristics of the connector to the impedance characteristics of the channel. These values may relate to the inductance and capacitance of the connector, the via, the pad and/or the edge fingers, for example, so that the characteristic impedance of the connector matches the channel impedance (i.e., the impedance of the transmission line). As will be described, various inductance and capacitance values may be chosen for each of the structural features of the connector such as the via, the pads and/or the edge fingers. Inductance and capacitance values may be analyzed to realize desired filter characteristics while also obtaining the desired impedance matching. This minimizes the impedance discontinuity and allows a desired filter response (i.e., cutting off certain frequencies) to be obtained along the bus. In essence, a designer may determine a combination of inductance and capacitance values that provides a desired frequency response while still matching (or approximately matching) the impedance of the connector (or connector components) with the impedance of the transmission line.

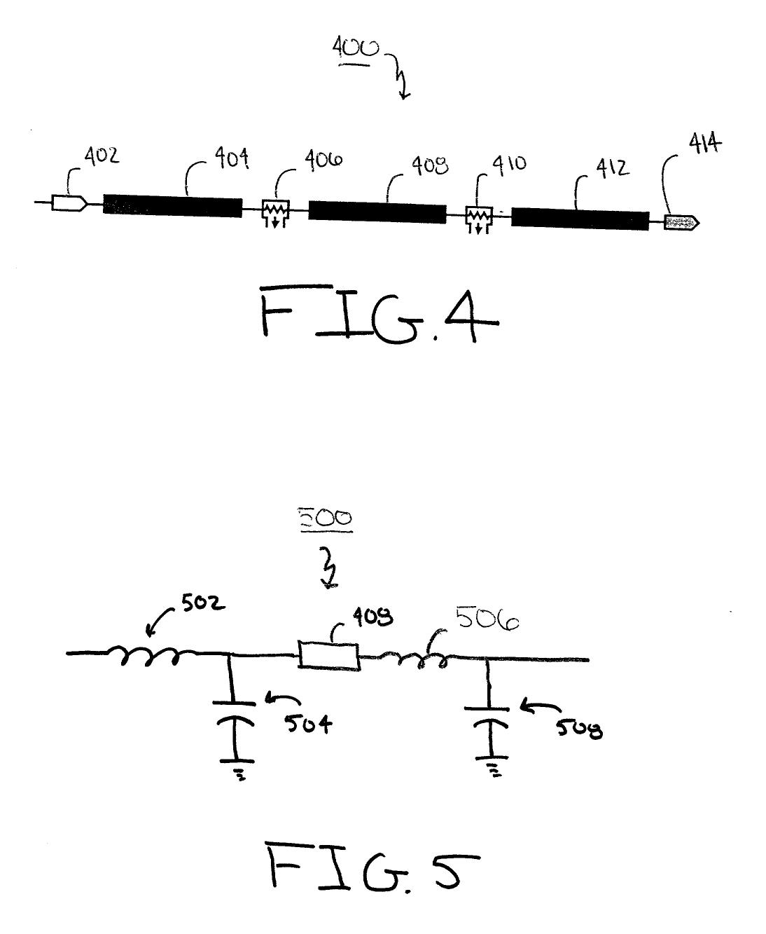

FIG. 4 is a drawing showing one embodiment of a driver and receiver implementation 400 having two connector transitions between three transmission line sections. More particularly, FIG. 4 shows a driver 402 coupled to a first transmission line 404. The first transmission line 404 is coupled to a second transmission line 408 by a first connector 406 (i.e., a first connector transition). The second transmission line 408 is coupled to a third transmission line 412 by a second connector 410 (i.e., a second connector transistor). The third transmission line 412 is coupled to a receiver 414.

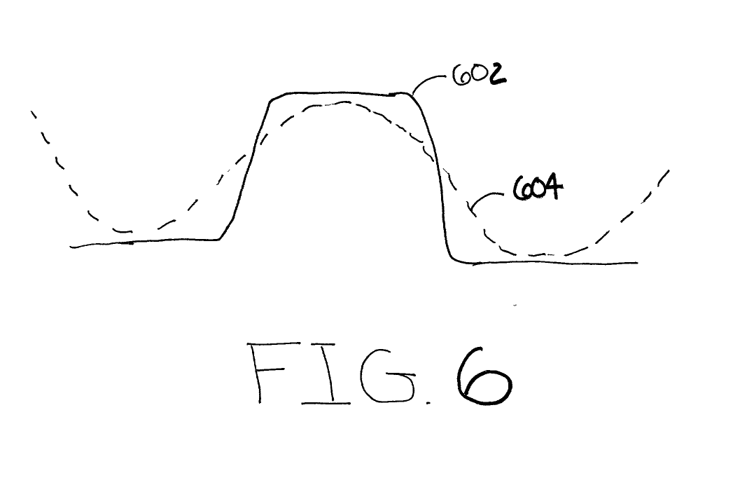

FIG. 5 is a drawing showing one embodiment of a low-pass ladder network 500 that utilizes the inductance and capacitance electrical characteristics of connectors (such as the connectors 406 and 410). The figure shows the corresponding inductance and capacitance of the connector portions for the topology. More specifically, FIG. 5 shows a connector inductance 502 and a connecter capacitance 504 that may correspond to electrical values of the connecter 406. FIG. 5 also shows a connector inductance 506 and connecter capacitance 508 that may correspond to electrical values of the connector 410. In accordance with embodiments of the present invention, these inductance and capacitance values may be matched (or approximately matched) to a filter polynomial that can be scaled in pole frequency location and the inductance and capacitance values may also be matched (or approximately matched) to the channel impedance (i.e., the impedance of the transmission line).

As described above, parasitics of the connector (or connector components) may be used to achieve filter-like responses. For example, FIG. 6 shows an output 602 of a driver (such as the driver 402) in the form of a square wave. FIG. 6 also shows an input 604 to a receiver (such as the receiver 414) after having traversed across a transmission line and through various modules on a motherboard. Because it is difficult to get a sine wave output from a driver, embodiments of the present invention may adjust parasitics of the connector to filter off portions of the square wave and minimize effects of high frequency harmonics.

As discussed above, embodiments of the present invention may use parasitics of the connector(s) to match to the channel impedance over the desired bandwidth and implement the connector(s) as a filter so as to reduce undesirable high frequency content. Properties of the connector may thereby be altered to improve bus signaling. Proper electrical inductance and capacitance values may be implemented into the connecter(s) so as to place a pole at the proper frequency and optimize it to a filter polynomial that has virtually no phase distortion, such as a bessel filter function. This may minimize the reflections due to high frequency effects by attenuation and thereby reduce the high frequency energy on the bus. This is desirable since driver stages, such as a CMOS buffer, even with edge rate controls, may output square wave signals with fast rise times that have a wide bandwidth. However, if the signal propagation along the transmission line (i.e., through the channel) is reduced to a sinusoidal source by utilizing the connector as a filter transfer function, then the designed bandwidth may be reduced to only the fundamental frequency of the sine wave. Also, if no phase distortion occurs, then signal amplitude losses can be compensated by the silicon using loss equalization.

Stated differently, as bus frequencies increase, the electrical characteristics of the connector may reach a condition where the electrical parasitics may create a pole in the frequency response in the critical bandwidth of a high speed bus design. When this condition is reached, the connector may represent a discontinuity that may effect the magnitude and phase of voltage as the signal propagates along the transmission line. If phase distortion occurs on a digital signal (having the output 602 of a square wave), then ringing and overshoot may occur. This may cause the signal quality to degrade. It is desirable that no phase distortion may occur within the bandwidth of the bus to provide good signal quality.

Accordingly, when designing and implementing a computer assembly (such as that of FIG. 1), a designer may desire to match (or approximately match) the channel impedance to the connector impedance to minimize the impedance discontinuity. The connector impedance may be viewed as the square root of (L_{connector}+Lᵥᵢₐ+L_{pad})/(C_{connector}+Cᵥᵢₐ+C_{pad}). In this embodiment, the impedance is characterized by using electrical values of a connector, a via and a pad. However, the present invention is not limited to these features as the connection transitions (such as connection transitions 52, 54, 56 and 58) may or may not contain these three features or other features. Other types of connection transitions are also known to those skilled in the art. The inductance and capacitance values of those features may be used to determine the connector impedance. The inductance and capacitance values may be varied to match (or approximately match) with the channel impedance. In order to match the connector impedance with the channel impedance, different values of inductance and capacitance may be selected for each of the features such as the connector, the via and the pad, for example. Therefore, in accordance with the embodiments of the present invention, a designer (or properly programmed computer system) may mathematically select the proper inductance and capacitance values to obtain a desired filter characteristic. That is, electrical values that satisfy the impedance matching (i.e., impedance of channel matches impedance of connector(s)) may be analyzed to determine a combination (of inductance and capacitance values) that provides a desired frequency response. The desired filter characteristics may be obtained by altering properties of a connector in an initial design of the computer system. The bandwidth of the computer system may thereby be limited to obtain a desired response. The inductance and capacitance values of a connector, a via, a pad, an edge finger, and/or other component affecting the connection transition may be altered from an initial design to obtain the desired filter response. The inductance and capacitance values may be obtained by altering any one or combination of the following: the shape of a contact; the length of the contact; the pitch of a contact; the edge finger pad geometry; and the pad of a surface mount connector. Other methods and means of adjusting the impedance of the connector (or connector components) are also within the scope of the present invention.

Accordingly, when designing a computer system having connector transitions, in addition to impedance matching to reduce impedance discontinuities, one may select desired inductance and capacitance values in order to realize a desired filter transfer function.

Embodiments of the present invention may provide a method of designing a computer assembly. This may include obtaining a design of the computer assembly having a transmission line and a connection portion. An impedance value of the transmission line may be matched (or approximately matched) to an impedance value of the connection portion so as to obtain a desired filter characteristic.

Embodiments of the present invention may also provide a computer assembly that includes a motherboard, a module to mount to the motherboard through at least one connection transition and a transmission line to pass from the motherboard to the module through the at least one connection transition. The connection transition may be designed and fabricated to match an impedance of the transition line to an impedance of the connection transition and obtains a desired filter characteristic. The desired filter characteristic may be a limited bandwidth along the transmission path of the computer assembly. The desired filter characteristic may also be a predicted frequency response. Other types of desired filter characteristics are also within the scope of the present invention.

Thus, embodiments of the present invention allow a connector to use its filter responses to tune the signal quality. That is, certain frequencies may be passed along the transmission line while others are cut off. That is, the unwanted bandwidth may be rolled off. This may be particularly advantageous as bus frequencies increase.

Although the present invention has been described with reference to a number of illustrative embodiments thereof, it should be understood that numerous other modifications and embodiments can be devised by those skilled in the art that will fall within the spirit and scope of the present invention. More particularly, reasonable variations and modifications are possible in the component parts and/or arrangements of the subject combination arrangement within the scope of the foregoing disclosure, the drawings and the appended claims without departing from the spirit of the invention.

What is claimed is:

1. A method comprising:
determining a desired filter characteristic for a computer system having a transmission path; and
altering at least one property of a connection transition component along said transmission path to obtain said desired filter characteristic.

2. The method of claim 1, wherein said altering said at least one property obtains said desired filter characteristic and at least approximately matches an impedance value of a transmission line to an impedance value of said connection transition.

3. The method of claim 1, wherein said at least one property comprises a shape of a contact of said connection transition component.

4. The method of claim 1, wherein said at least one property comprises a length of a contact of said connection transition component.

5. The method of claim 1, wherein said at least one property comprises a pitch of contacts of said connection transition component.

6. The method of claim 1, wherein said at least one property comprises geometry of an edge finger of said connection transition component.

7. The method of claim 1, wherein said desired filter characteristic comprises a limited bandwidth along said transmission path of said computer system.

8. The method of claim 1, wherein said desired filter characteristic comprises a predicted frequency response.

9. A method of designing a computer assembly comprising:
obtaining a design of said computer assembly having a transmission line and a connection portion to connect a motherboard to a module; and
altering said design such that an impedance value of said transmission line at least approximately matches an impedance value of said connection portion and obtains a desired filter characteristic.

10. The method of claim 9, wherein said altering comprises altering at least one property of said connection portion.

11. The method of claim 10, wherein said at least one property comprises a shape of a contact of said connection portion.

12. The method of claim 10, wherein said at least one property comprises a length of a contact of said connection portion.

13. The method of claim 10, wherein said at least one property comprises a pitch of contacts of said connection portion.

14. The method of claim 10, wherein said at least one property comprises geometry of an edge finger of said connection portion.

15. The method of claim 10, wherein said desired filter characteristic comprises a limited bandwidth along said transmission line of said computer system.

16. The method of claim 10, wherein said desired filter characteristic comprises a predicted frequency response.

17. A computer assembly comprising:
a motherboard;
a module to mount to said motherboard through at least one connection transition; and
a transmission line to pass from said motherboard to said module through said at least one connection transition, wherein said connection transition is designed such that an impedance value of the transmission line matches an impedance of the connection transition and obtains a desired filter characteristic.

18. The assembly of claim 17, wherein said connection transition is designed by altering at least one property of said connection transition.

19. The assembly of claim 18, wherein said at least one property comprises a shape of a contact of said connection transition.

20. The assembly of claim 18, wherein said at least one property comprises a length of a contact of said connection transition.

21. The assembly of claim 18, wherein said at least one property comprises a pitch of contacts of said connection transition.

22. The assembly of claim 18, wherein said at least one property comprises geometry of an edge finger of said connection transition.

23. The assembly of claim 17, wherein said desired filter characteristic comprises a limited bandwidth along said transmission line of said computer system.

24. The assembly of claim 17, wherein said desired filter characteristic comprises a predicted frequency response.
